(19) United States
(12) Patent Application Publication
(10) Pub. No.: US 2007/0166428 A1
(43) Pub. Date: Jul. 19, 2007

(54) Internal high pressure forming installation

(75) Inventors: Helmut Augustin, Hamburg (DE); Kai-Uwe Dudziak, Stelle (DE); Stefan Schwarz, Luenen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/573,253

(22) PCT Filed: Aug. 20, 2004
(86) PCT No.: PCT/EP04/09334

§ 371 Date: Dec. 12, 2006

(30) Foreign Application Priority Data
Sep. 23, 2003 (DE) 103 43 868.8

(51) Int. Cl. B29C 45/18

(52) U.S. Cl. 425/567

(57) ABSTRACT

An internal high pressure forming installation is provided, in which a forming tool with upper and lower dies form a forming chamber for pressure forming a closed hollow profile. The installation has at least one axial punch which can seal the hollow profile be sealed at one end and apply an internal high pressure to expand the hollow profile. The installation includes a rapid filling device which can pre-fill the hollow profile with pressurized fluid when the axial punch is drawn back from the hollow profile end. In order for the production of hollow profiles to be suitable for mass production in a simple manner, the filling attachment is transported on the axial punch which brings the filling attachment into a contact position on the forming tool in order to fill it and, after the filling, guides it into a position remote from the forming tool.

This application is a national phase application of International application PCT/EP2004/011070 filed Oct. 5, 2004 and claims the priority of German application No. 103 48 895.2, filed Oct. 15, 2003, the disclosure of which are expressly incorporated by reference herein.

### BACKGROUND AND SUMMARY OF THE INVENTION

The invention relates to an internal high pressure forming installation and the related equipment and equipment operation.

An internal high pressure forming installation of the generic type is disclosed in U.S. Pat. No. 5,235,836 and U.S. Pat. No. 6,279,364 B1. The installation revealed therein has a corresponding, two-part forming tool, in the forming chamber of which a peripherally closed hollow profile is inserted. For sealing during the forming process, the installation has at each end an axial stamp in which, in addition, an axial through channel is formed via which the hollow profile is expanded by means of a pressurized fluid which is placed under high pressure. The installation furthermore contains a rapid filling device with a filling attachment. The filling attachment has a filling bore, the diameter of which is larger than that of the through channel and via which the hollow profile is filled in a position of the axial punch in which it is drawn back from the hollow profile end. Furthermore, the filling attachment has a through bore through which the axial punch protrudes during the forming of the hollow profile in order to seal the latter. The axial punch forms a transporting device which brings the filling attachment into a contact position on the forming tool in order to fill it and, after the filling is finished, transfers it into a position which is remote from the forming tool. Filling attachment and axial punch are arranged displaceably relative to each other, with the filling attachment being supported annularly by the axial punch.

DE 196 286 88 C1 describes an internal high pressure forming installation which contains a rapid filling device for filling a hollow profile, which is inserted in the cavity formed by the upper part and lower part of the forming tool of the installation, with pressurized fluid. According to an exemplary embodiment, the rapid filling device is formed by two filling attachments which are attached opposite each other to the outside of the forming tool. The filling attachments have a through bore entered in each case by an axial punch by means of which the profile inserted into the forming tool is to be sealed at both ends. While one filling attachment has a filling bore which opens into the through bore, the other filling attachment has a discharge bore at which the pressurized fluid can emerge after filling is complete.

The filling operation proceeds as follows: the axial punch is in a position in which it is drawn back from its sealing position and in which the mouth of the filling bore is opened up into the through bore. The pressurized fluid is now conveyed via a pressurized fluid line, which is connected to a water reservoir and in which, if appropriate, a pressurized fluid pump is integrated, via the filling bore into the through bore and from there into the hollow profile interior. Since the cross-sectional opening of the filling bore is substantially larger than the axial through channel within the axial punch, by means of which an internal high pressure can be produced in the hollow profile, the pressurized fluid does not enter the hollow profile in a high-energy jet but rather such a large volume of pressurized fluid is introduced that the hollow profile is flooded. This causes the air previously situated in the hollow profile to be rapidly and completely displaced, said air escaping via the discharge bore of the other filling attachment.

After filling is complete, the axial punches are driven in such a manner that they completely penetrate the filling attachments and seal the ends of the hollow profile. In the process, the mouth opening of the filling bore of the one filling attachment and the exit opening of the discharge bore of the other filling attachment are blocked by the axial punches. If the forming of the hollow profile and, as a result, its expansion by means of the internal high pressure are now ended, the pressurized fluid is depressurized and the punches are drawn out of the filling attachments. Subsequently, the filling attachments, which are attached to the forming tool, are removed, so that the forming tool can open. Finally, the ready-formed hollow profile is removed from the forming tool. Although the production time for producing the hollow profile is shortened by the rapid filling, this gain in time is overcompensated for by the laborious removal of the filling attachments that is required for the removal of the hollow profile. In addition, installation and removal of the filling attachments are relatively complicated requiring manual skill, with the result that the internal high pressure forming installation described is entirely unsuitable, due to the assembly pauses which arise, for series production, in which it is endeavored to form a large number of hollow profiles within the shortest possible time.

The invention is based on the object of developing an installation of the generic type to the effect that the production of hollow profiles formed by internal high pressure is suitable in a simple manner for mass production, the production making use of a rapid filling device, which is integrated in the installation, for filling the hollow profile.

Owing to the invention, the axial punch has a stop which is in the vicinity of the forming tool. Furthermore, the installation contains a device with which the filling attachment is held on the forming tool during the filling. The effect achieved by the device is that the filling attachment is fixed to the outside of the forming tool when the axial punch is moved up to said forming tool. Depending on the holding force, this results in a sealing of the filling attachment on the forming tool to a greater or lesser extent. Secondly, the stop, which has a counterstop on that side of the filling attachment which faces the forming tool, acts as a carry-along element for the filling attachment when the expansion of the hollow profile is ended and the axial punch is seen in its draw-back movement. As a result, the filling attachment can be lifted off the forming tool without the axial punch sliding under it.

With regard to the reliability of the function of the filling attachment, on the one hand, and the sealing function of the axial punch that is to be brought about later, on the other hand, it is immensely important that, when the filling attachment is in contact with the forming tool during the filling operation, the axial punch is in a position in which it is drawn back from the forming tool and still has a sufficient displacement distance toward the forming tool, so that, in the forming phase of the hollow profile, it can enter the latter in a sealing manner. For a smooth-running relative displaceability of the filling attachment and of the axial punch with respect to each other, it is necessary for this to proceed in a manner low in friction, which can be brought about, for example, by a sliding bearing on the axial punch.

In order to ensure adequate grip or, if appropriate, even an adequate contact pressure force of the filling attachment on the forming tool, a plurality of solutions are possible. For example, it is conceivable for the axial punch to be surrounded by a hollow punch which can be controlled independently of the axial punch and acts upon the filling attachment with a contact pressure force at least during the filling time. As an alternative, movable pins are also conceivable which, in the same manner as the hollow punch, engage on the rear side of the filling attachment and press the latter onto the outside of the forming tool during the filling operation. As a further alternative with regard to holding the filling attachment on the forming tool, it is conceivable for means, such as, for example, a latching device, to be arranged on said forming tool, into which means the filling attachment can enter during docking and can be latched in place there. In order to release the latching after expansion of the hollow profile has taken place, this can take place by suitable activation of the latching device or in a simple manner by the draw-back movement of the axial punch, during which movement the filling attachment then bears against the stop of the axial punch that is in the vicinity of the forming tool and, after a certain latching force is exceeded, is unlatched from the latching device.

Said device according to the invention for holding the filling attachment on the forming tool is formed by a compression spring by means of which the rigid filling attachment is supported on the outside on a radially outwardly situated step of the axial punch. By means of the use of the compression spring, the rapid filling device, and therefore the internal high pressure forming installation, is substantially simplified, since the compression spring firstly does not require any separate controlling means and secondly can be positioned in an extremely simple manner on the axial punch. The compression spring effectively presses the filling attachment against the forming tool and the stop of the axial punch that is in the vicinity of the forming tool. In the sealing movement of the axial punch, the compression spring additionally results in a particularly strong seal, since the spring force increases in the sealing movement of the axial punch on account of the compression of the compression spring and, in the process, the contact pressure force of the filling attachment on the forming tool is raised by an extreme amount. After forming of the hollow profile has taken place, the axial force of the axial punch, which it needs for sealing, is neutralized, as a result of which the compression spring is relieved from load. As a consequence thereof, the compression spring expands and thereby facilitates the releasing of the axial punch from the hollow profile, since said axial punch may be jammed there on account of a metallic seal with the hollow profile end, by said compression spring, owing to its relaxation, pressing said axial punch outward.

As an alternative, the filling attachment is a flexible bellows which is fastened to the axial punch in the region of the through bore. Although the bellows is fastened on the axial punch, the flexibility of the bellows enables the axial punch to be displaced in the axial direction relative to the bellows for sealing purposes, with the bellows being pressed in by the axial punch in the sealing movement. Owing to its otherwise fixed arrangement on the axial punch, the bellows is pressed from the axial movement of the axial punch, as it approaches the forming tool, onto the outside of the forming tool in a simple manner. Other devices for pressing the filling attachment on the forming tool or holding it thereon, as are required in the case of a rigid embodiment of the filling attachment, can be omitted here in a simple manner. Owing to the elasticity of the bellows, sealing means are not required on the end side of the bellows when in contact with the forming tool either, since the corresponding sealing elements are formed by the bellows itself. Furthermore, the bellows has resilient characteristics which, after the forming of the hollow profile and relieving of load on the drive side have taken place, reset the axial punch again into its inoperative state. In the process, the bellows also returns into its shape in which it is not pressed in. Therefore, no special means for returning the axial punch into its inoperative position are required here either.

The filling attachment is brought in a simple manner by means of the transporting device to the forming tool and can be held there during the filling operation, with the device, after the filling, bringing the filling attachment again into a position remote from the forming tool. Installation and removal are unnecessary in this case, with the result that the time associated therewith is saved. The outlay on guiding in and drawing back the filling attachment requires only a small outlay and needs only little transporting and positioning time. For example, handling devices under fully programmed control, such as robots, are conceivable for this. Since the filling attachment is not attached to the forming tool, after the forming of the hollow profile is finished said forming tool can be opened virtually immediately afterwards and the ready-formed hollow profile can be removed therefrom and it can be loaded with a new hollow profile which is yet to be formed. This drastically reduces the cycle time in such a manner that the production process of the hollow profile, in which use is made of a rapid filling device for filling the hollow profile prior to the beginning of the internal high pressure forming process, is suitable for mass production.

Since the axial stamp forms the transporting device, the filling attachment being arranged on the in a manner such that it can be displaced relative to the latter in the axial direction, the construction of the entire internal high pressure forming installation is considerably simplified, since the transporting function is taken over by already existing parts of the installation. So that, after the hollow profile is filled via the filling attachment docked on the forming tool, the axial punch can seal the hollow profile for the expansion process, the filling attachment and the axial punch are designed in a manner such that they can be displaced relative to each other in the axial direction. The transfer of the function of the transporting device to the axial punch furthermore results in the advantage that the filling attachment does not still have to be aligned separately with the cavity of the forming tool, since the axial punch, in order to be able to provide a seal, is already aligned with the cavity and therefore also takes over the alignment of the filling attachment.

In a further preferred refinement of the invention, the filling attachment is designed in the manner of a bell. Owing to the particularly large cross section of the interior space of the bell, which space is open toward the forming tool, a relatively large bandwidth of hollow profiles of different diameter can be rapidly flooded, it also being of advantage in terms of apparatus that just a single filling attachment can be used for a multiplicity of hollow profiles of different diameter. Furthermore, a plurality of filling bores which are formed in the wall of the filling attachment can also open into the voluminous interior space of the bell, with the result that the large interior space of the bell can be filled particularly rapidly with pressurized fluid, which, in consequence, shortens the filling time of the hollow profile.

In a further preferred refinement of the invention, a peripheral seal is arranged on the end side of the filling attachment, which end side faces the forming tool. By use of the seal, which is preferably designed as an elastomer ring, firstly the end side of the filling attachment and the contact surface of the forming tool are protected from wear and secondly the filling leakage is prevented during the filling operation.

In a further advantageous refinement of the invention, the filling attachment, via which the hollow profile can be filled, has a vent bore. The effect thereby achieved in a simple manner is that the filling attachment can be used at the same time to fill the hollow profile and to remove the air initially situated therein. Furthermore, the air which, in the case of the refinement of the filling attachment of a bell, is situated in the interior thereof, can also escape via the vent bore. The vent bore is advantageously arranged in the filling attachment above the tool cavity.

In a further preferred refinement of the invention, the filling attachment, via which the hollow profile can be filled, has an outlet bore. The outlet bore is situated in a lower section of the filling attachment, as seen geodetically, and is blocked during the filling operation. The outlet bore serves to enable the pressurized fluid which is situated in the hollow profile and the filling attachment to be removed in a specific manner after forming of the hollow profile has taken place and the axial punch has been drawn back out of the hollow profile. This enables pressurized fluid resources to be saved.

Other objects, advantages and novel features of the present invention will become apparent from the following detailed description of the invention when considered in conjunction with the accompanying drawings for example.

### BRIEF DESCRIPTION OF THE DRAWINGS

FIG. 1 shows, in a partial lateral longitudinal section, an internal high pressure forming installation according to an embodiment of the invention with a forming tool and a rapid filling device with a filling attachment which is displaceable relative to an axial punch of the installation,

FIG. 2 shows, in a partial lateral longitudinal section, an internal high pressure forming installation according to an embodiment of the invention with a rapid filling device and a forming tool with a filling attachment of the rapid filling device, the filling attachment being fastened on an axial punch of the installation and being designed as an elastic bellows.

### DETAILED DESCRIPTION

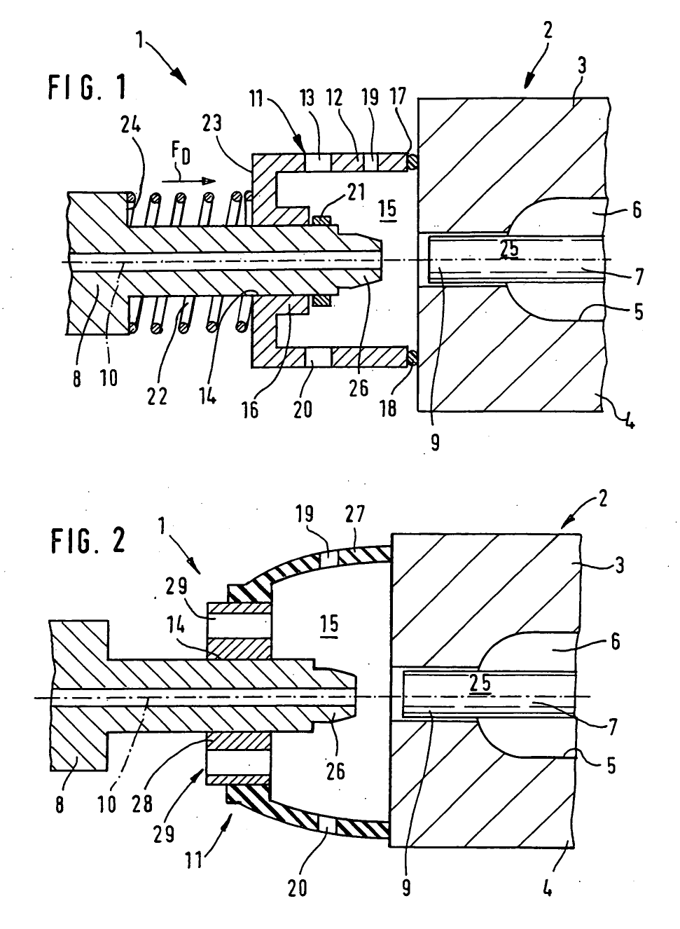

FIG. 1 illustrates an internal high pressure forming installation 1 which contains a forming tool 2 which is composed of an upper die 3 and a lower die 4. The cavities 5 of the upper die 3 and the lower die 4 form a forming chamber 6 for a peripherally closed hollow profile 7 which is to be inserted therein and here has already been placed therein. Furthermore, the internal high pressure forming installation 1 has at least one axial punch 8 by means of which the inserted hollow profile 7 can be sealed at one end 9 and which has an axial through channel 10. The through channel 10 is connected on the rear side of the axial punch 8 to a fluid high pressure generating installation, as a result of which, in the operative position of the axial punch 8, an internal high pressure can be produced with pressurized fluid via the passage channel 10 in the hollow profile 7 in order to expand it. In addition, the internal high pressure forming installation 1 also contains a rapid filling device 11 which contains a filling attachment 12 which is designed in the manner of a bell and, in its wall, has a filling bore 13, the diameter of which is larger than the diameter of the through channel 10 of the axial punch 8. Via the filling bore 13, the hollow profile 7 is filled with pressurized fluid, in a position of the axial punch 8 in which it is drawn back from the respective hollow profile end 9, in the low pressure range under a pressure of approximately 1 to 50 bar, and is therefore flooded. The filling attachment 12 has a through bore 14 through which the axial punch 8 protrudes during the forming process of the hollow profile 7. The filling attachment 12 is connected to a transporting device which brings the filling attachment 12 into a contact position on the forming tool 2 in order to fill it and, after the filling, guides it into a position remote from the forming tool.

In the present exemplary embodiment of FIGS. 1 and 2, the transporting device is formed by the axial punch 8 itself, the filling attachment 12 being arranged with its through bore 14 on the axial punch 8 in a manner such that it can be displaced relative to the latter in the axial direction. Instead of a bell shape, the filling attachment 12 may also have any other desired shape, with it being advantageous for a rapid filling free from air bubbles if the filling attachment 12 has a voluminous interior space 15, as is shown here. The filling attachment may be formed from steel, plastic, a light metal or other suitable construction materials. On its through bore 14, the filling attachment 12 has a guide collar 16, which is driven into the interior space 15, for guiding the axial punch 8. A peripheral seal 18 in the form of an O-ring is arranged on the end side 17 of the filling attachment 12, which side faces the forming tool 2. In addition to its filling bore 13, instead of which it is also possible for a plurality of filling bores to be arranged, a vent bore 19 for removing the air situated in the interior space 15 of the filling attachment 12 and in the hollow profile 7 is formed in the upper region of the filling attachment 12. An outlet bore 20 is formed in the filling attachment 12, in a region which is situated below the cavity 5, to which outlet bore an outlet line can be connected and via which, after the forming of the hollow profile 7, the pressurized fluid can be conducted away from the latter and from the interior space 15 of the filling attachment 12. The axial punch 8, which also projects in its inoperative position into the interior space 15 of the filling attachment 12, has, following the guide collar 16 of the filling attachment 12, a stop 21 which is in the vicinity of the forming tool and is in the form of a hard material ring which is fastened on the circumferential surface of the axial punch 8. The internal high pressure forming installation 1 furthermore contains a device by means of which the rigid filling attachment 12 is held on the forming tool 2 during the filling. This device, which can be based on mechanical or hydraulic principles of action, is formed here by a compression spring 22 by means of which the rigid filling attachment 12 is supported by its outside 23 on a radially outwardly situated step 24 of the axial punch 8.

For the production process sequence, first of all a hollow profile 7 is inserted into the cavity 5 of the forming tool 2, after which the latter is closed. The axial punch 8 then moves to the forming tool 2 until the filling attachment 12 bears with its seal 18 of the end side 17 against the forming tool 2. In order to obtain sufficient sealing, the axial punch is displaced a short distance further in the direction of the forming tool 2, as a result of which the compression spring 22 is somewhat compressed, so that the filling attachment 12 is pressed against the forming tool 2 by the spring force F_{D}. Then a pressurized fluid is introduced via a fluid line from a fluid reservoir through the filling bore 13 and the interior space 15 of the filling attachment 12 into the hollow profile interior 25, as a result of which the hollow profile 7 is flooded. The air within the hollow profile 7 and the interior space 15 of the filling attachment 12 escapes in the process through the vent bore 19. After the filling of the hollow profile 7, the axial punch 8 is moved further in the direction of the forming tool 2, as a result of which the compression spring 22 is compressed even more and the filling attachment 12 is pressed even more strongly against the forming tool 2. Furthermore, it is also conceivable, in the case of the use of two axial punches 8 which close both ends 9 of the hollow profile 7 in a sealing manner and which are in each case assigned a rapid filling device 11, to provide the filling bore 13 only in the one axial punch 8 and to provide the vent bore 19 in the other axial punch 8. In this case, during the filling via the filling bore 13, the air situated in the hollow profile 7 is entrained by the volumetric flow of the pressurized fluid and escapes to the outside via the vent bore 19 of the other punch 8.

Finally, the axial punch 8 enters with its punch head 26 into the end 9 of the hollow profile 7 and seals off the latter from the internal high pressure which is to be produced. Furthermore, the fluid high pressure generating installation is set in motion which introduces pressurized fluid, which is under high stress, via the through channel 10 into the hollow profile interior 25, so that the hollow profile 7 is expanded until it comes into contact with the cavity 5.

After expansion has taken place, the pressurized fluid is then depressurized and the drive of the axial punch is relieved of load. This relieving of load causes the compression spring 22 to expand in the axial direction and to press the axial punch 8 back into its inoperative position. The axial punch 8 is then moved back until the filling attachment 12 lifts off the forming tool 2 and the latter is then opened to remove the hollow profile 7, which is now ready-formed. Before the axial punch 8 is moved back, the outlet bore 20 is opened, after which the pressurized fluid collected in the hollow profile 7 and in the interior space 15 of the filling attachment 12 can be removed in a specific manner.

In a departure from the rapid filling device 11 of the above exemplary embodiment, as can be gathered from FIG. 2, the filling attachment 12 is designed as an elastic, flexible bellows 27. The bellows 27, which is likewise of bell-shaped design, is connected fixedly to the axial punch 8 in the region of the through bore 14. This can take place, for example, by means of adhesive bonding, soldering or injection molding and by clamping, preferably by means of a clamping ring. The bellows 27 furthermore has a rigid filling sleeve 28 in which the through bore 14 is formed and which has filling bores 29 on the upper side and lower side. The filling sleeve 28 is grasped centrally by the flexible part of the bellows 27. The filling sleeve 28 serves, owing to its rigid design, to enable the fluid lines to be better connected.

In order to fill the hollow profile 7, as before, the axial punch 8 is moved in the direction of the forming tool 2 until the bellows 27 bears against the outside of the forming tool 2. In order to obtain a sealing pressing on of the filling attachment 12, the axial punch 8 is displaced a short distance further in the direction of the forming tool 2, as a result of which the bellows 27 is pressed in a little, but is prestressed owing to its elasticity, with the result that the prestressing force is converted into a force pressing the filling attachment 12 against the forming tool 2. Subsequently, the interior space 15 of the bellows 27 is filled via the filling sleeve 28 or the filling bores 29 thereof with pressurized fluid which automatically flows further into the hollow profile 7 and floods the latter. The air in the bellows 27 and in the hollow profile 7 escapes through the vent bore 19. The air removal alternative described in the previous exemplary embodiment is also conceivable here. After the filling operation is finished, the axial punch 8 is moved forward until its punch head 26 enters the end 9 of the hollow profile 7 and, in the process, seals the hollow profile 7. In this case, the bellows 27 is pressed in even more strongly and the force pressing the filling attachment against the forming tool 2 is considerably increased as a result. After the pressurized fluid is introduced via the through channel 10 of the axial punch 8 and an internal high pressure is produced in the hollow profile interior 25, the forming or expansion of the hollow profile 7 begins until the latter bears against the cavity 5 of the forming tool 2. The outlet bore 20, which is formed in the lower region of the bellows 27, then opens, so that the pressurized fluid, which is under normal pressure within the hollow profile 7 and the interior space 15 of the filling attachment 12, can be removed in a simple manner. Finally, the axial punch 8 is relieved of load, after which the latter is guided back into its inoperative position by the resilience of the elastic bellows 27. When the drive of the axial punch 8 is used in the return direction, the bellows 27 finally lifts off the forming tool 2, as a result of which the latter can be opened and the hollow profile 7 can be removed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-6. (canceled)

7. An internal high pressure forming installation, comprising:
a forming tool, said forming tool including an upper die and a lower die which together form a forming chamber therebetween to receive a peripherally closed hollow profile;
at least one axial punch, wherein said axial punch is adapted to seal an end of the inserted hollow profile located in said forming chamber, and has an axial through channel for transmission of pressurized fluid into the hollow profile in order to expand it within the forming chamber;
a rapid filling device including a filling attachment, said filling attachment
having with a filling bore with a diameter which is larger than a diameter of the at least one axial punch through channel,
being adapted to fill the hollow profile with pressurized fluid when the at least one axial punch is not sealing the end of the hollow profile, and
having a through bore through which the axial punch protrudes when sealing the end of the hollow profile, and
wherein
the axial punch serves as a transporting device for bringing the filling attachment into a contact position on the forming tool to permit filling of the hollow profile when located the hollow profile is within the forming chamber, and, after filling, to guide the filling attachment into a position remote from the forming tool,
the filling attachment is axially displaceable on the axial punch,
the axial punch has a stop which retains the filling attachment, and a device which holds the filling attachment on the forming tool during filling, and
the device is a compression spring which supports the filling attachment by applying a spring force against a radially outwardly situated step of the axial punch.

8. The internal high pressure forming installation as claimed in claim 7, wherein the filling attachment is a flexible bellows which is fastened to the axial punch in the region of the through bore of the filling attachment.

9. The internal high pressure forming installation as claimed in claim 7, wherein the filling attachment is bell-shaped.

10. The internal high pressure forming installation as claimed in claim 8, wherein the filling attachment is bell-shaped.

11. The internal high pressure forming installation as claimed in claim 7, wherein an encircling seal is arranged on an end side of the filling attachment which is adapted to be brought into the contact position on the forming tool.

12. The internal high pressure forming installation as claimed in claim 8, wherein an encircling seal is arranged on an end side of the filling attachment which is adapted to be brought into the contact position on the forming tool.

13. The internal high pressure forming installation as claimed in claim 9, wherein an encircling seal is arranged on an end side of the filling attachment which is adapted to be brought into the contact position on the forming tool.

14. The internal high pressure forming installation as claimed in claim 7, wherein.

15. The internal high pressure forming installation as claimed in claim 11, wherein the filling attachment is bell-shaped.

16. The internal high pressure forming installation as claimed in claim 7, wherein the filling attachment has a vent bore.

17. The internal high pressure forming installation as claimed in claim 7, wherein the filling attachment has an outlet bore.
